(19) United States
(12) Patent Application Publication
(10) Pub. No.: US 2018/0288993 A1
(43) Pub. Date: Oct. 11, 2018

(54) Packaged stealthy mosquito trap

(71) Applicant: Dana A. Focks, Gainesville, FL (US)

(72) Inventor: Dana A. Focks, Gainesville, FL (US)

(73) Assignee: JOHN W HOCK COMPANY

(21) Appl. No.: 15/731,017

(22) Filed: Apr. 6, 2017

(51) Int. Cl. A01M 1/10; A01M 1/06; A01M 1/04

(52) U.S. Cl. CPC A01M 1/106; A01M 2200/012; A01M 1/04; A01M 1/06

(57) ABSTRACT

A mosquito trap having a motor and fan to draw ambient air radially into the trap with the airflow going downwards through a large insect exclusion screen into and through a collection cup cloth netting and into and through a collection cup and through a second screen at the bottom of the collection cup. In preferred embodiments all of the other components of the trap can be easily and compactly stored in the collection cup prior to and after use in the field.

### FIELD OF THE INVENTION

The present invention relates to mosquito trap and in particular to compact stealthy mosquito traps.

### BACKGROUND OF THE INVENTION

Since World War II, the US Department of Defense (DoD) has spent considerable resources to protect deployed war fighters from vector-borne diseases transmitted by mosquitoes, ticks, and sand flies. When a force is deployed, they are accompanied by one or more preventive medicine (PM) personnel; one of their critical responsibilities is to determine if there are any threats of vector-borne disease in the theatre such as dengue, malaria, and leishmania, viz., the PM conduct medical entomology surveillance of adult vectors. If a threat of vector-borne disease exists, the PM team will attempt to reduce the vector population with insecticides and/or recommend that the troops use personal protection products such as repellents or insecticide-treated uniforms. Central to the this risk assessment is the collection of adult vectors using traps baited with incandescent light. Vector traps are typically used to collect flying female vectors:

(1) To evaluate control programs,

(2) To do taxonomic studies on the vectors themselves, or

(3) To isolate and/or identify any pathogens present.

The battery-operated vector traps in the DoD supply chain (e.g., National Stock Numbers: 3740-01-106-0091, 3740-01-457-5527, and 6545-01-457-5511) for mosquitoes and sandflies typically consist of a three-inch clear acrylic cylinder housing an aspiration motor and fan which blows the adult vectors down into a white two-ringed collection bag; on top of the cylinder is a rain shield to shield the collection bag and an incandescent light that serves as the attractant. The DoD trap was originally developed in the early 1960's by the Centers for Disease Control (CDC) and Prevention. Typically DoD vector traps have a photo switch which turns the trap on at evening time; the following day when light levels go up, the switch will turn off the light to save battery charge but leave the fan running to keep the specimens blown down in the hanging collection bag. The primary purpose of the photo switch is to minimize the current required by the trap so that the time required for recharging is minimalized.

Typically, a PM entomologist will distribute four to twelve traps during the course of a day, each with a fresh lead-acid battery and an empty collection bag. Later in the day, as ambient light levels go low, the trap will start both the aspiration fan and a miniature incandescent light which will run during the night hours; in the morning the photo switch will turn off the light but leave the motor running so as to keep the live specimens in the collection bag; the light is switched off during the day to save battery power and reduce recharging time. To obtain statistically-relevant population data estimates on the vectors, a PM will run each of the traps in a particular location for three or four nights per week. Because the goal of adult vector surveillance is to provide risk assessment for humans, whether US forces or local populations, the placement of the traps is almost always in view of local population; as will be discussed below, this sequential running of a trap in the same location creates a potential safety and theft problem for the PM technicians.

Each of the traditional DoD light traps require two six-volt lead-acid batteries, two collection bags, and a charger that uses the local mains voltage. The PM entomologists have limited volume in the standard entomological kit used in deployments so the trap size and battery requirements are problematic and limiting.

Various trapping devices are available which are used for monitoring or surveillance of mosquitos and similar blood sucking insects. Typically, the traps such as those used by DoD (aka: the traditional light trap also known as the CDC miniature light trap) are baited with visible light emitted from nothing more sophisticated than a flash light bulb. The use of light traps to for mosquitos and similar insects with relevance as disease vectors has been studied by many researchers since the mid-1920's. With regard to DoD's surveillance in deployments for the vectors of illnesses like malaria, the CDC light trap's use of incandescent bulbs has several draw backs:

(1) For the level of light emitted, incandescent bulbs are inefficient and consume two- or three-times the amount of current used by the aspiration fan, hence the requirement of heavy lead-acid batteries, chargers, and photo switches. While inefficiencies and heavy lead-acid batteries requirements are a drawback in deployments, these issues have been surmountable.

(2) However the chief drawback of using incandescent light as an attractor is that the visible wavelengths do not attract all medically important vectors. In the developed world, the release of carbon-dioxide (CO₂) gas from cylinders or dry ice is often used to enhance the catch for these species; however these sources of CO₂ often are not available in deployments. An example of how significant this is to DoD, consider the primary malaria vector in south Asia ranging from Egypt to China, Anopheles stephensi: it does not come to incandescent light-baited traps without CO₂.

An alternative attractor for these difficult-to-collect species in lieu of incandescent light and CO₂ has been the use of fluorescent tubes emitting a mixture of blue and long wave black light (UV-A). The problems of blue-black irradiation from fluorescent tubes include:

1) Blue-black light fluorescent tubes actually emit significant radiation in the blue visible light range (450-495 nm) and a smaller portion in the long ultra violet range (ultraviolet A (UVA) 315-400 nm).

(2) Fluorescent tubes require an additional piece of electronics, a transistorized inverter ballast which converts the six volt DC input to 25 volts VAC (RMS) at 38 kHz. The required input current is 0.48 amps, a more than 2.3-fold that of the incandescent bulb typically used (CM-47). With regard to deployments, this increased current consumption requires the use of a 6 VDC and 20 amp hour battery, twice the size of the normal light trap battery of six VDC and 10 amp hour battery.

The United States Department of Defense (DoD) has recently developed an interest in developing a mosquito and sand fly trap that:

(1) Does not draw so much attention to itself, viz., a trap without the visible light serving as mosquito/sand fly attractor and

(2) Does not require carbon dioxide but still capturing all species of hematophagous (blood sucking) insects.

(3) Does not require so much battery current to operate,

(4) And can operate on virtually any battery in the DoD supply chain, e.g., Lithium-ion battery packs, alkaline disposable batteries, sizes AA to D, and automotive/truck lead acid batteries (12 VDC).

What is needed is a better mosquito trap satisfying the desires of the DoD.

### SUMMARY OF THE INVENTION

The present invention provides a mosquito trap having a motor and fan to draw ambient air radially into the trap with the airflow going downwards through a large insect exclusion screen into and through a collection cup cloth netting and into and through a collection cup and through a second screen at the bottom of the collection cup. In preferred embodiments all of the other components of the trap can be easily and compactly stored in the collection cup prior to and after use in the field. Preferred embodiment of the present invention are designed to address DoD's specific issues in vector surveillance. Applicant refers to this trap as his “Stealth Trap (Model 2014)”. The trap includes or provides:

(1) A trap that can use as the attractant either an incandescent bulb or a LED array emitting in the blue-black spectrum (UV-A) or both the incandescent bulb and the LED array. The trap can also be run without any radiation, i.e., a simple suction trap.

(2) A visible incandescent light equivalent to the standard CM-47 bulb, such that data from the new trap can be directly compared with data from the traditional light trap conducted previously in past years.

(3) Ultra-violet (361 nm) attractive radiation from an array of LEDs that attracts every known genera and species of hematophagous adult flying vector without the release of CO₂. The LEDs are not soldered into the circuit, so UV LEDs can be swapped out for any other LED emitting infrared, visible or ultraviolet (UV-A) light.

(4) A built-in power converter so that the new trap can operate on virtually any battery with output voltages in the range of 3.8 volts to 24 volts which includes a large number of power sources in the DoD supply chain including: lithium-ion battery packs, alkaline disposable batteries, sizes AA to D, and automotive/truck lead acid batteries (12 VDC).

(5) A trap that is physically smaller than the traditional DoD light trap.

(6) A trap that has very low visibility to humans because of the UV-A attractor and the camouflaged surfaces of the trap and collection cup.

Embodiments of the invention utilizes a motor and fan to draw ambient air radially into the trap with the airflow going downwards through an insect-exclusion screen (designed to exclude insects larger than mosquitoes) into a collection cup cloth netting and out of the collection cup and through a second screen downstream of the collection cup. In preferred embodiments all of the other components can be easily and compactly stored in the collection cup prior to and after use in the field.

Preferred embodiments include a printed circuit board which provides:
An array of eight LEDs which are arranged radially around the periphery of the board,
An incandescent light bulb,
Photo switch functionality, and
Three switches to select
   1) Incandescent light,
   2) LED UV light,
   3) Incandescent light and UV light, or
   4) No light at all.

In preferred embodiments the large insect exclusion screen is designed to exclude large insects like beetles which would damage mosquito or sand fly specimens in the collection cup. The fan and fan motor are mounted on the motor-mounting plate, and the fan support bracket is spot welded to a rain shield mounting bracket. To conserve space the trap assembly, power cord, and collection sock are designed to be stored inside the collection cup to provide a logistically compact package to be air-shipped to deployment areas and then taken to a trap site and assembled into the trap.

### BRIEF DESCRIPTION OF THE DRAWINGS

FIG. 1 is an exploded view of a preferred embodiment of the present invention.

FIG. 2 is a prospective view of the preferred embodiment assembled and ready to catch mosquitos.

FIG. 3A is a drawing showing a prospective view of the ABS body of the trap.

FIG. 3B is side view of the body and identifying various features of it.

FIG. 4A shows a top view of the trap which is a view of the rainshield.

FIG. 4B shows some of the component located inside the trap body.

FIG. 4C shows a prospective view of the components located inside the trap body.

FIG. 4D shows some of the components of the trap that are inside the body or attached to it.

FIG. 5 shows the array of LED UV lights, a single incandescent light, and the switches.

FIG. 6A shows a prospective view of the collection cup.

FIG. 6B is a side view of the collection cup cut away to demonstrate how all of the other components of the tap can be conveniently stored inside of the prior to or after use of the trap.

FIG. 7A is a sub-circuit designed to protect the LCS-04 circuit from input voltages outside of the range of 40 to +40 VDC.

FIG.7B is a sub-circuit designed to provide input voltage cutoff.

FIGS. 7C and 7D present the sub-circuits used to drive the aspiration fan.

FIG. 8A is a circuit controlling the incandescent light.

FIGS. 8B and 8C present the sub-circuits for providing constant current to the two strings of four LEDs each.

FIG. 9 describes a buck/boost regulator.

FIG. 10A shows the light beams from the LED array and the incandescent bulb.

FIG. 10B is similar to FIG. 10A also showing a hole for an electric power cord.

### DETAILED DESCRIPTION OF PREFERRED EMBODIMENTS

### Features of the 2014 Stealth Trap

A preferred embodiment of the present invention is called the “Model 2014 Stealth Trap” by Applicant and was designed to deal with adult mosquito and sand fly surveillance problems specific to the U.S. Department of Defense (DoD) when on foreign deployments. This embodiment of the present invention can be described by reference to the drawings. Problem using traditional DoD light traps have been uniquely addressed in the Stealth Trap design include the following inter-related issues:

(1) Traditional DoD light traps require a large rain shield because of the size of the two-ringed collection bag, i.e., the traps are not compact. This restricts the number of traps used in a deployment, a logistical issue; this has been a persistent issue and a work-around has not yet been found.

(2) The DoD standard light trap is not efficient electrically because of the incandescent bulb which consumes more current than the aspiration fan. Hence the requirement for heavy 10-12 amp hour six-volt batteries, two per trap because of the recharging time each day.

(3) Battery issues affect vector surveillance in deployments using the traditional DoD issued light trap. Single sealed lead acid (SLA) batteries, typically 6 volt, 10-12 amp hours, can provide power for a single trap for a single night. Drawbacks to SLA batteries are that they are heavy, require charging and chargers, and the available line voltage in the deployment areas are often different than that required by the charger (e.g., 240 VAC, 50 Hz vs. 110 VAC, 60 Hz). The other power source in the DoD logistic supply line are disposable alkaline D-cell batteries, typically 4 batteries in series, again providing power for a single trap and night. The problem with alkaline disposable batteries (and SLA batteries) is the loss of voltage with discharge; this results in lower aspiration fan speeds and perhaps more importantly a diming of the attractive incandescent light where with discharge it goes from emitting white light to more yellow light and more infrared light which is not attractive to mosquitoes. The result is disposal of alkaline batteries with perhaps as much as half their capacity remaining. A significant third problem regarding batteries should be mentioned—the very common 12 volt battery or Lithium-ion battery packs (8.4 VDC) already available in the logistics supply chain cannot be used on prior art 6-volt surveillance traps.

A key feature of the Stealth Trap is its electrical efficiency when using the LEDs; running the aspiration fan and LEDs alone (1.68 watts) requires 25% fewer watts that when running the fan and the incandescent light bulb (2.10 watts). Probably the more exciting and useful feature of the power supply used in the trap is that it can take as input voltage anything from 3.8 to 40.0 VDC. This feature allows virtually every type of battery in DoD's logistic supply chain, alkaline AA and D-cells, 6, 12, or 24 volt sealed lead acid batteries, and Lithium-ion batteries with their superior weight and size ratios. A thirty-amp 12 volt sealed lead acid motor cycle battery would give twelve days of 12 hours night and 12 hour daytime with only the fan; a Ford F-150 12-volt truck battery on a single full charge would give more than a year's worth of current (377 days). The Stealth Trap is the ONLY trap for mosquito surveillance which can take a range of input voltage and there by enable virtually any battery in the DoD logistical supply chain be used; moreover, locally-acquired motorcycle, automobile, and truck batteries can be used and sourced while in-country on deployments.

(4) The attraction of the traditional DoD light traps is an incandescent light bulb. For many BUT NOT ALL of the more than 3,000 species of mosquitoes and sand flies in the world, an incandescent light provides an adequate attraction. But for many medically-important vector species, the attraction of visible light is insufficient. An example of how significant this is to DoD, consider the primary malaria vector in south Asia, Anopheles stephensi: it does not come to incandescent light-baited traps. In the United States, the incandescent attraction light is often enhanced using the release of carbon-dioxide (CO₂) which is typically NOT available in deployment areas, hence preferred embodiments of the present invention include the use of ultraviolet (UV-A) radiation for deployment surveillance.

(5) Regular and repeated once-a-day trap attending creates a risk to PM techs from their enemies. The same visible light of the traditional DoD vector surveillance trap that attracts mosquitoes and sand flies can attract the attention of hostile forces embedded within the civilian population.

(6) A requirement of using a sampling site for three or four nights per week using a highly visible device often leads to trap AND battery loss, pilfering. So making the trap stealthy is important for several reasons.

(7) Applicant and the scientific literature indicate that UV-A radiation attracts (in contrast to visible light radiation, i.e., incandescent light) every genera and species of hematophagous insects. Then why does the new Stealth Trap incorporate both and incandescent and UV LED lights? DoD's traditional incandescent-based light traps (NSN: 3740-01-106-0091) have been made by Applicant's assignee, the John W. Hock Company and used on US deployments and in the United States for almost four decades. For some locations overseas and within the United States and its protectorates, years or even decades of daily or weekly data derived from the traditional (incandescent) light trap exist; season to season and year to year comparison are made for control efforts and risk assessment. The traditional traps with incandescent lamps were used because many of the targeted species came to incandescent traps. DoD still needs traps with incandescent lamps so that data from the traps can be effectively correlated with data accumulated over the past decades. Applicant's Stealth Trap when running an incandescent bulb, without the UV LEDs, is basically identical to the traditional light traps in terms of light output and intake air speed. So the Stealth Trap can be used in these areas and the data are comparable to earlier data sets. The result is that the traditional light trap can be replaced with the Stealth Trap for all locations and data obtained from the traps can be compared to many years of existing data obtained using the prior art incandescent lights. This is a significant issue with DoD, especially on US facilities.

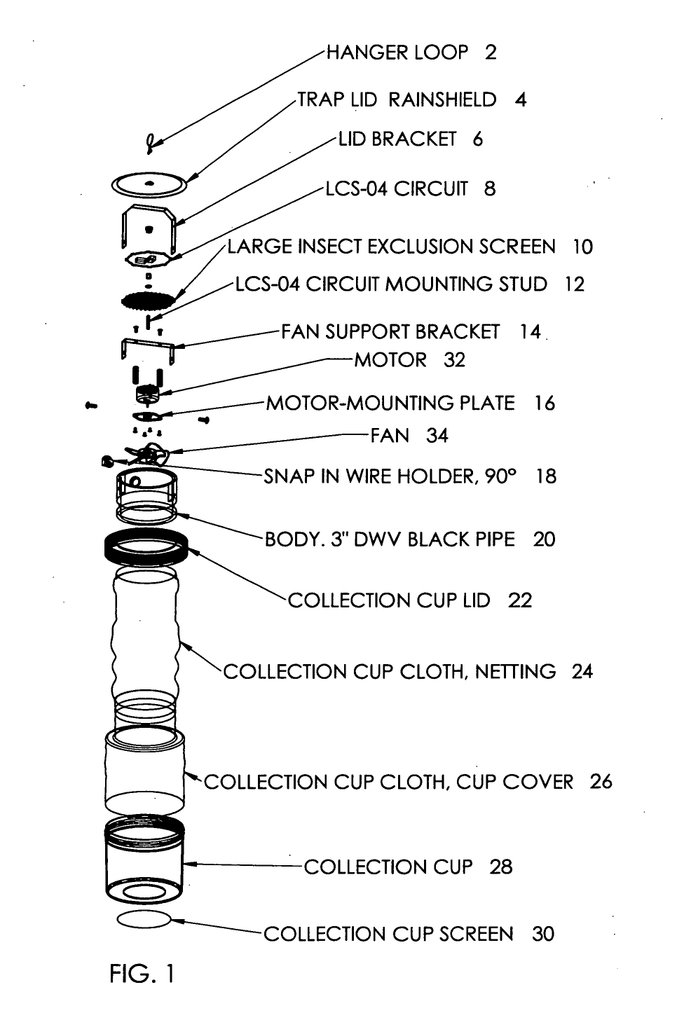

Preferred embodiments of the present invention can be described by reference to the drawings: FIG. 1 is an exploded view of a preferred embodiment of the present invention. Applicant has identified this embodiment as “Model 2014 Stealth Trap”. From top to bottom this embodiment includes hanger loop 2; trap lid and rain shield 4; lid bracket 6; and constant voltage/current circuit board 8 which includes a photo switch and other switches (Applicant designates this circuit board as his LCS-04 circuit board); large insect exclusion screen 10; LCS-04 mounting bracket 12; fan support bracket 14; motor-mounting plate 16; fan motor 32; fan 34; snap in wire holder, e.g., a strain relief for the power cord 18; trap body comprised of a three-inch ID piece of ABS foam-core black drainage pipe 20; collection cup lid 22; collection cup cloth netting 24; collection cup cloth, cup cover 26, collection cup 28 and collection cup screen 30. (Note: the two items 22 and 24 are one part. The netting 24 is black screen fabric to connect trap to collection cup. The collection cup cloth cover 26 is made of thin fabric in camouflage pattern; the purpose of this is to cover the white exterior of the collection cup 28. The collection cup lid 22 may be screwed onto the cup 28 with all of the other components of the Stealth Trap (other than the battery) contained within the cup and lid. This keeps all of the components of the trap together between deployments.)

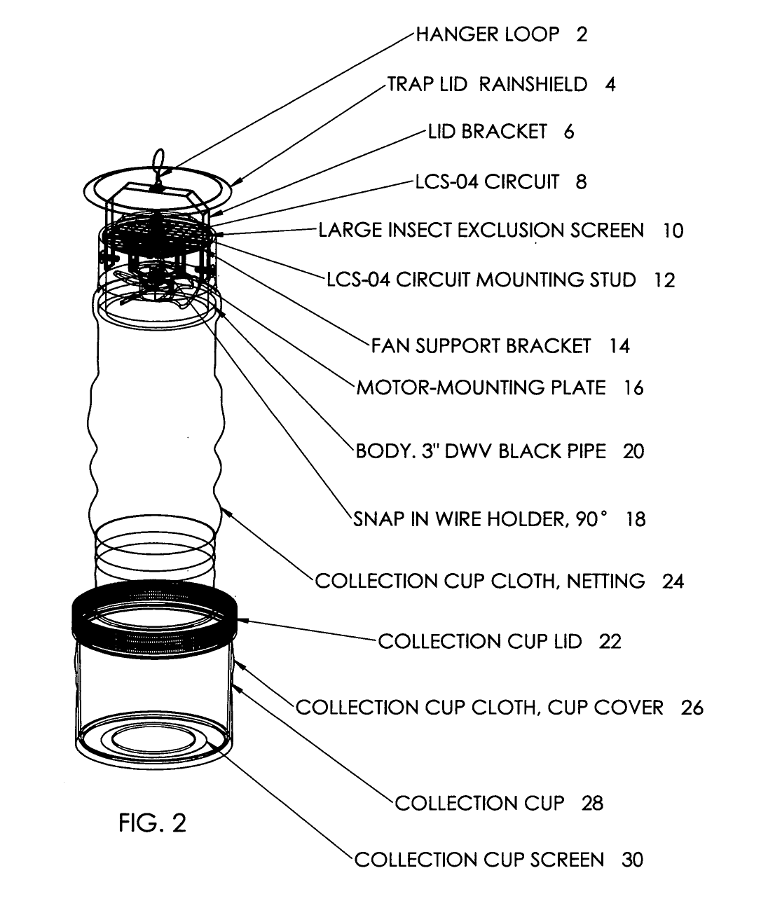

FIG. 2 is a prospective view of the preferred embodiment assembled and ready to catch mosquitos; the only part not included in FIGS. 1 and 2, FIGS. 6B and 10A and 10 B is the battery cable which is about two meters long. Air flow is radial into the trap between the top of the trap body 20 and under the rain-shield 4. Exhaust air flows down from the fan thru the sock, and out thru the collection cup bottom screen 30. The rain-shield 4 shields the LCS-04 circuit 8 from normal rainfall; however the LCS-04 is waterproof (The “LCS” stands for light switching circuit. The LCS-04 circuit board in Applicant's trap is fabricated, using off-the-shelf parts, by Sibex Electronics with offices in Crystal River Fla.) The collection cup cloth, netting 24 is sufficiently fine mesh and hydrophobic such that rainfall does not enter the collection cup and harm the specimens.

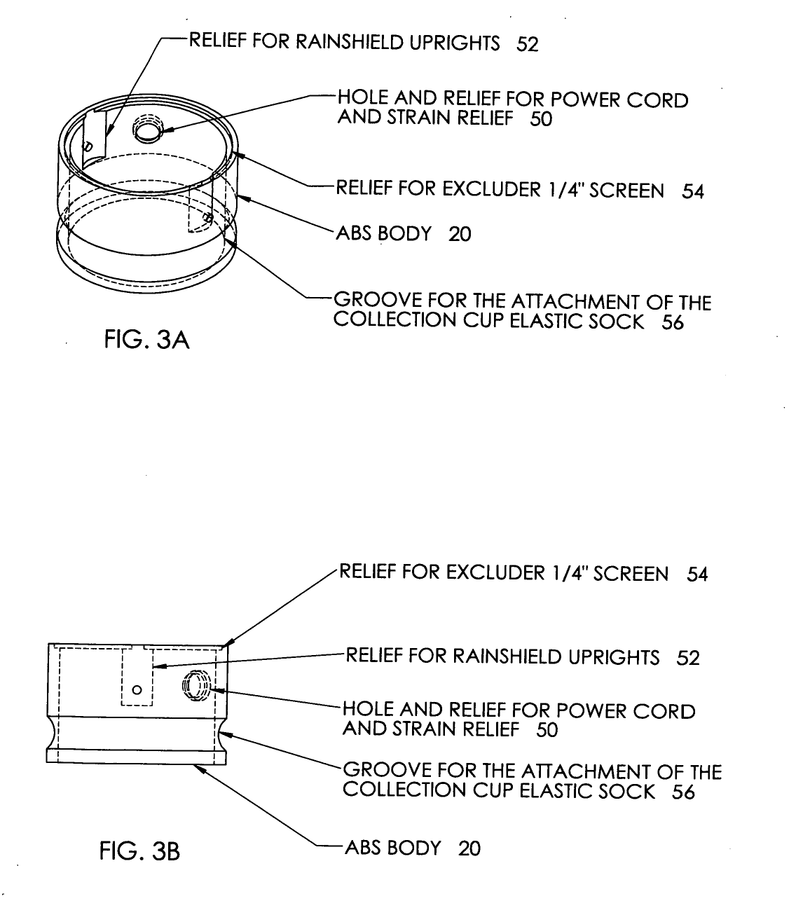

FIG. 3A is a drawing showing a prospective view of the ABS body of the trap 20 with the machined surfaces, e.g., relief for the excluder ¼″ screen 54, power cord and strain relief 50, and the relief for the rainshield uprights 52. Finally, the figure pictures the 360° groove at the base of the body 56.

FIG. 3B is side view of the body 20 and identifying various machined features of it.

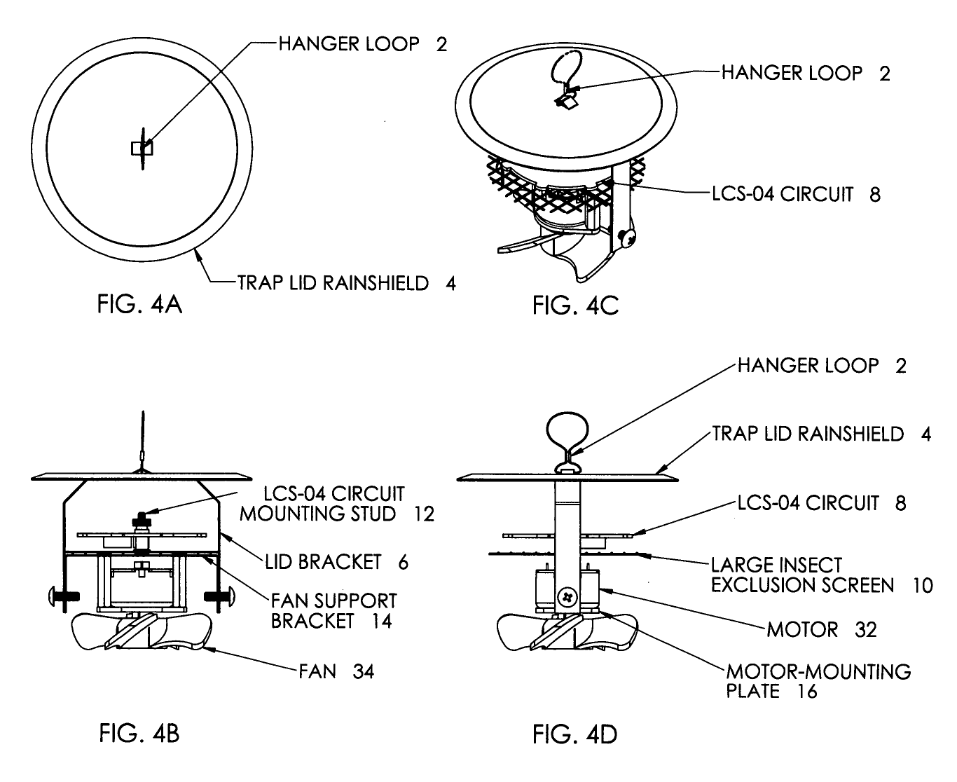

FIG. 4A shows a top view of the trap which is a view of the rain shield 4 and hanger loop 2.

FIG. 4B is a side view some of the components located inside the trap body 20.

FIG. 4C shows a prospective view of the component located inside the trap body, and

FIG. 4D shows some of the components of the trap that are inside the body or attached to it.

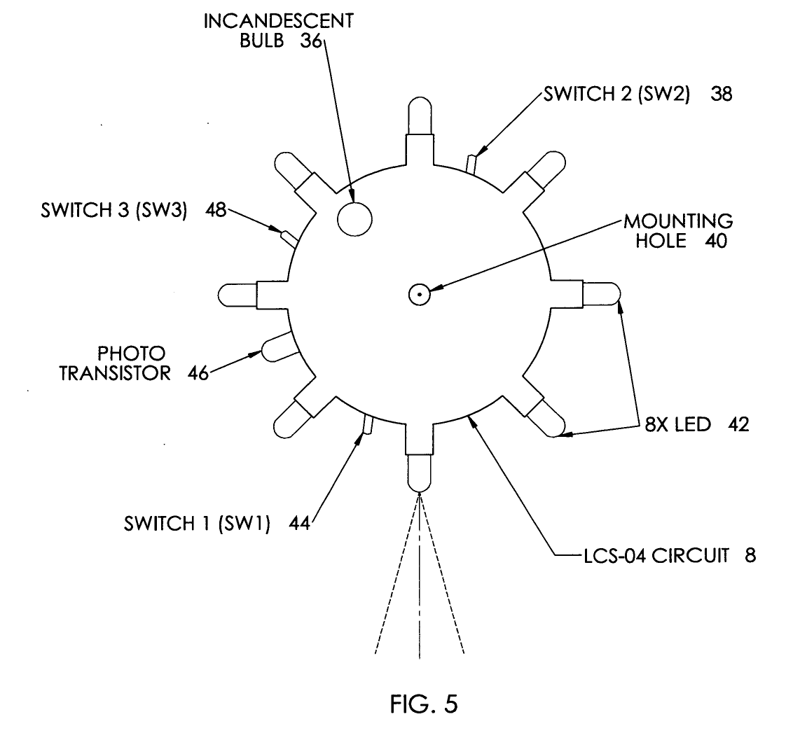

FIG. 5 shows the printed circuit board with its array of eight LED UV lights 42, a single incandescent light 36, switches one-three 38, 44, and 48, the circuit mounting hole 40, and the photo transistor 46.

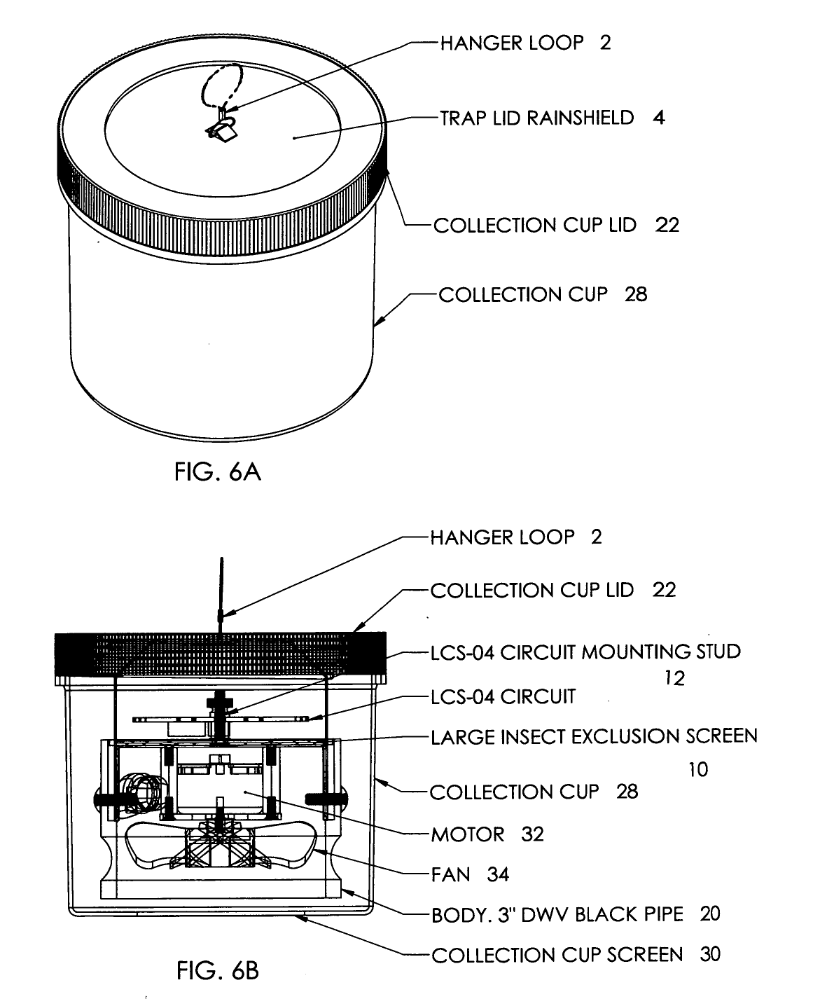

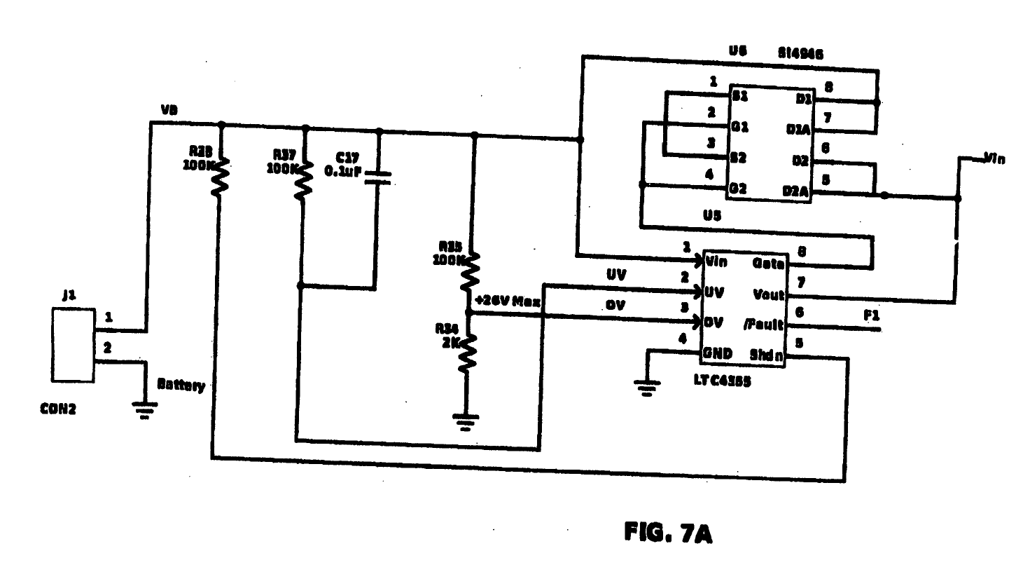

FIG. 6A shows a prospective and external view of the collection cup 28, the rainshield of the trap 4 with hanger loop 2, and the collection lid 22.

FIG. 6B is a side view of the same with the collection cup cut away to demonstrate how all of the other components of the tap can be conveniently stored inside of the prior to or after use of the trap. Not shown in this figure but items included inside the packed trap include the collection cup cloth netting 24, cup cover, and the power cord.

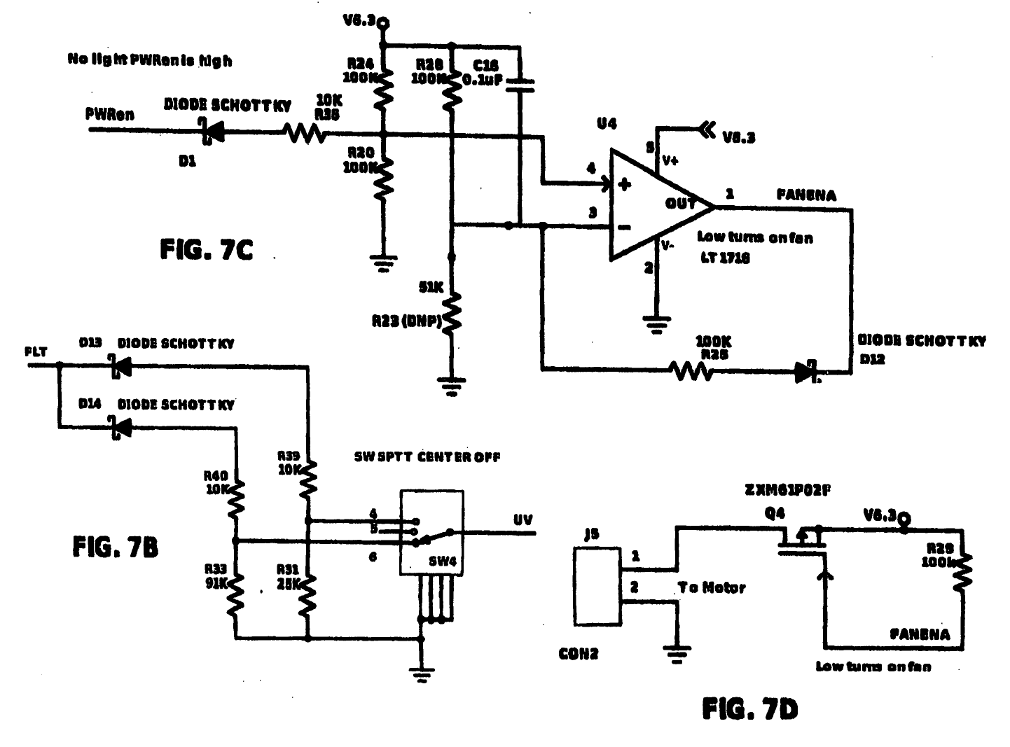

FIGS. 7A- through 9 are schematics of the sub-circuits of the printed circuit board (LCS-04) in the Stealth Trap.

FIG. 7A is a sub-circuit designed to protect the LCS-04 circuit from input voltages outside of the range of 40 to +40 VDC; input voltages outside of this range will cause the protection circuit to disconnect the other sub-circuits from the input voltage. However, it will only provide output when provided with electric power between about 4 to 26 VDC; while voltages between 26 and 40 VDC and negative voltages will not harm the circuit, at these input voltages the circuit does not output any current for the light(s) and/or motor. These input limits of the supply voltage to the rest of the circuit provides protection it from over voltage, under voltage and reverse voltage if the supply is plugged in backwards.

FIG. 7B is a sub-circuit designed to provide input voltage cutoff to protect lead-acid batteries from being over discharged. This sub-circuit includes a three-way switch (SW4) which allows the user to select the cut off voltage depending on what type of battery is being used so as to not drive gel-cell lead acid rechargeable batteries into harmful over discharge. In position 4 the shut off voltage is appropriate for a 6 VDC lead acid rechargeable battery (cutoff at ca. 5.25 VDC); position 6 is appropriate for the same type of battery in a 12 VDC version (cutoff at about 10.5 VDC). The intermediate (center) position 5 is for all other batteries, self-protected Li-ion batteries and non-rechargeable alkaline batteries; in this position the circuit will output to the fan motor and/or light(s) until minimum operational voltage is reached, ca. 3.8 VDC. The over voltage cutoff is always set to +26 VDC and is not affected by the position of SW4. The output of this circuit is called Vin and supplies all of the circuits that require protection.

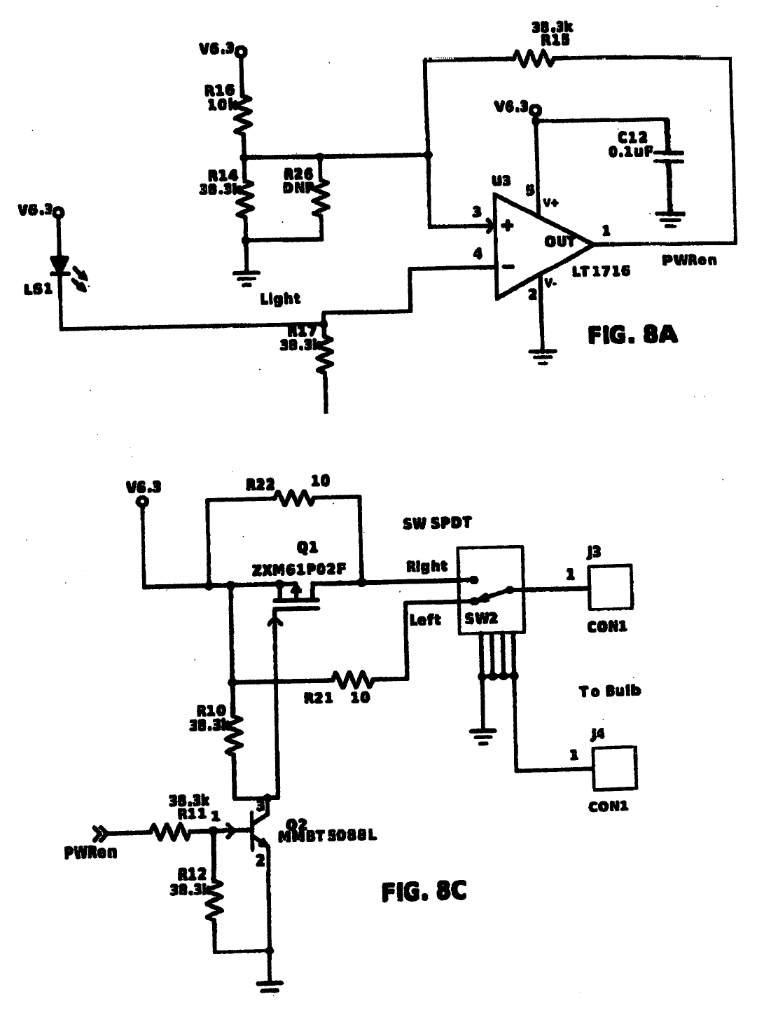

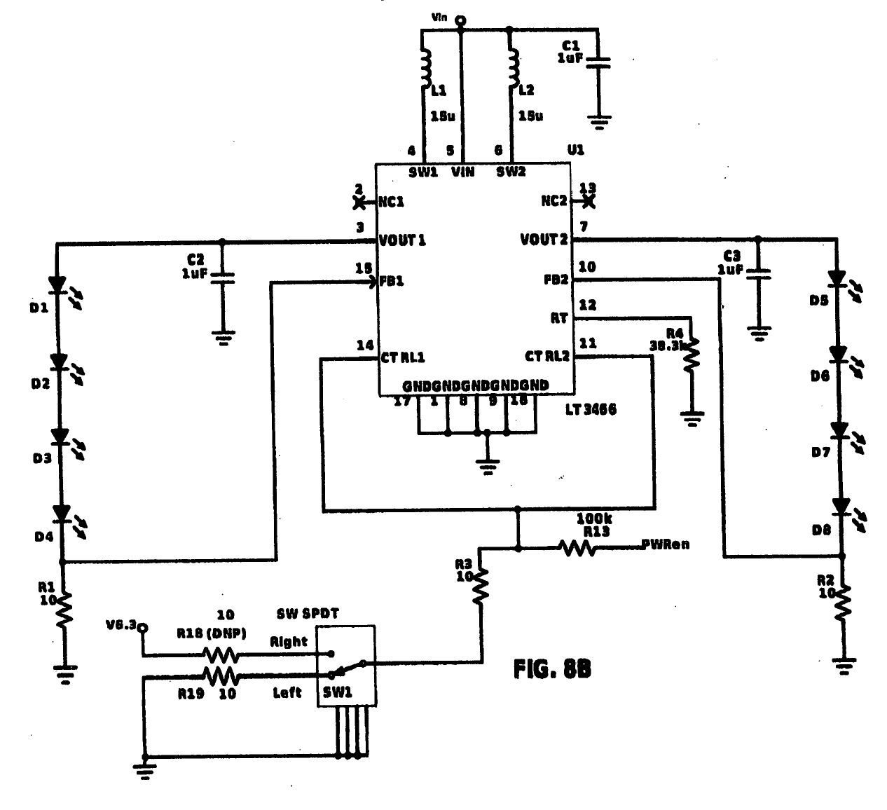

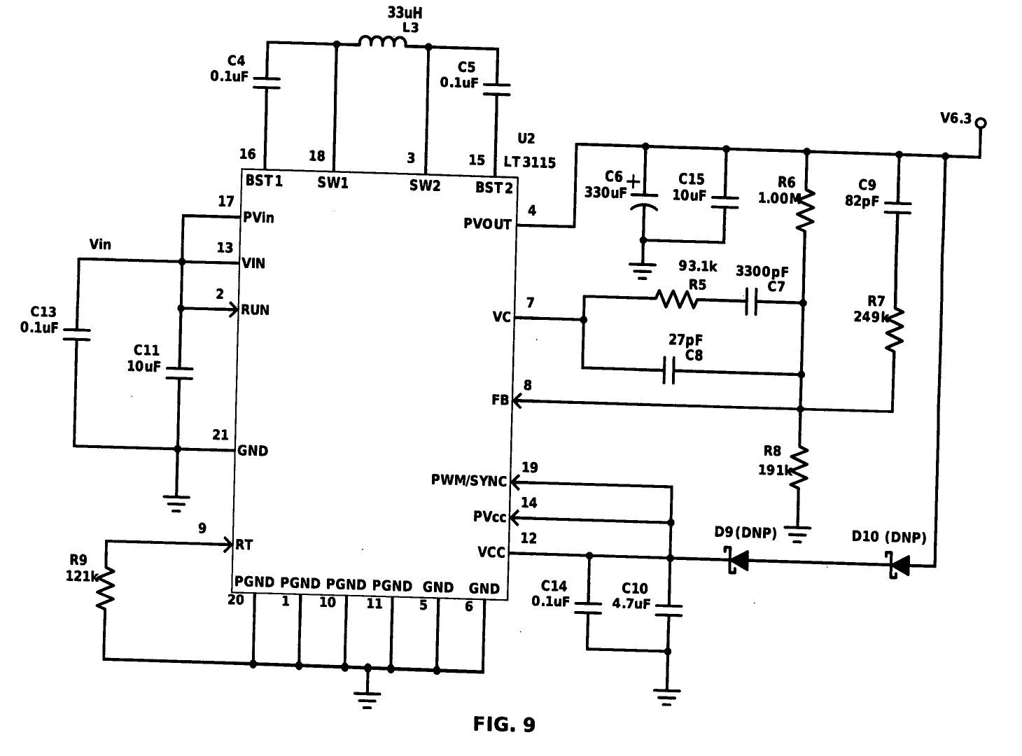

FIGS. 7C, 7D, and 8A are the schematics of the sub-circuits that sense ambient light for photo switch functionality and latches on the fan once started by low light levels. This second function keeps the fan running on daybreak until the trap is serviced for the next night's operation; this keeps the specimens blown into the collection cup.

The control system consists of two comparators run off of the 6.3 VDC from the buck/boost regulator (described below in FIG. 9). The first is a light sensor (FIG. 8A), consisting of one a light detector (LS1), a comparator and a level set resistors. The level is set to simulate a light input switch point similar to dusk or dawn.

When the light reaches a level that is bright enough, daytime, the output of the comparator will be driven low. The unit has hysteresis to prevent oscillation during this transition. The opposite is true at dusk. This output, PWRen is used to control other functions, described below.

If the trap is powered up during daytime, the fan will remain off; the fan will come on immediately if it is dark when the battery is attached. At the first dark time, PWRen goes low, latching the circuit for the fan which turns on the fan. This circuit consists of another comparator and bias networks. Once enabled by the PWRen going low, the latch switches its output low and keeps it low during dark or light times. This holds the fan off, if powered up during the day, but once it is dark, the fan turns on, and stays on until it is turned off by removal of power; the purpose here is to keep live specimens blown down into the collection until the trap is serviced with empty collection cup. The PWRen when high (dark time only), enables the incandescent bulb and circuit for the LED's as well.

The outputs of the control system are buffered from the loads, (LED's, incandescent bulb, and fan), by drive circuits described below.

FIGS. 7C and 7D present the sub-circuits used to drive the aspiration fan. The fan is controlled by an analog “latch”. This function has a time delay to hold off the fan until power is reached, and will hold the fan off if there is light, PWRen high. When PWRen goes low, the circuit will “latch” on to keep the fan running until the battery is disconnected or if there is a voltage supply outside of the range of the input protection circuit (see FIGS. 7A and 7B above).

The fan enable is buffered by a transistor pair, and may be overridden by SW2. This feature permits the trap to operate (motor and/or lights) continuously and independent of light levels.

FIGS. 8B and 8C present the sub-circuits for providing constant current to the two strings of four LEDs each. The LED driver is a dual output, constant current device which runs directly off of the input voltage, Vin. It will supply two chains of LEDs at a constant current set by a fixed resistor. The LED may be forced to turn on independent of light levels by SW2 if desired.

FIG. 9 presents the sub-circuit of the buck/boost regulator. The output of the input voltage protection circuit, Vin, discussed above, is applied directly to the input of the buck/boost regulator. The output of the input voltage protection circuit, Vin, discussed above, is applied directly to the input of the buck/boost regulator.

This buck/boost regulator will run off of the +4 to +26 VDC output of the input protection circuit and provide a steady +6.3 VDC for the entire system including the incandescent bulb. The regulator is output current limited, thermally limited, and short circuit protected, though no normal events will cause these conditions.

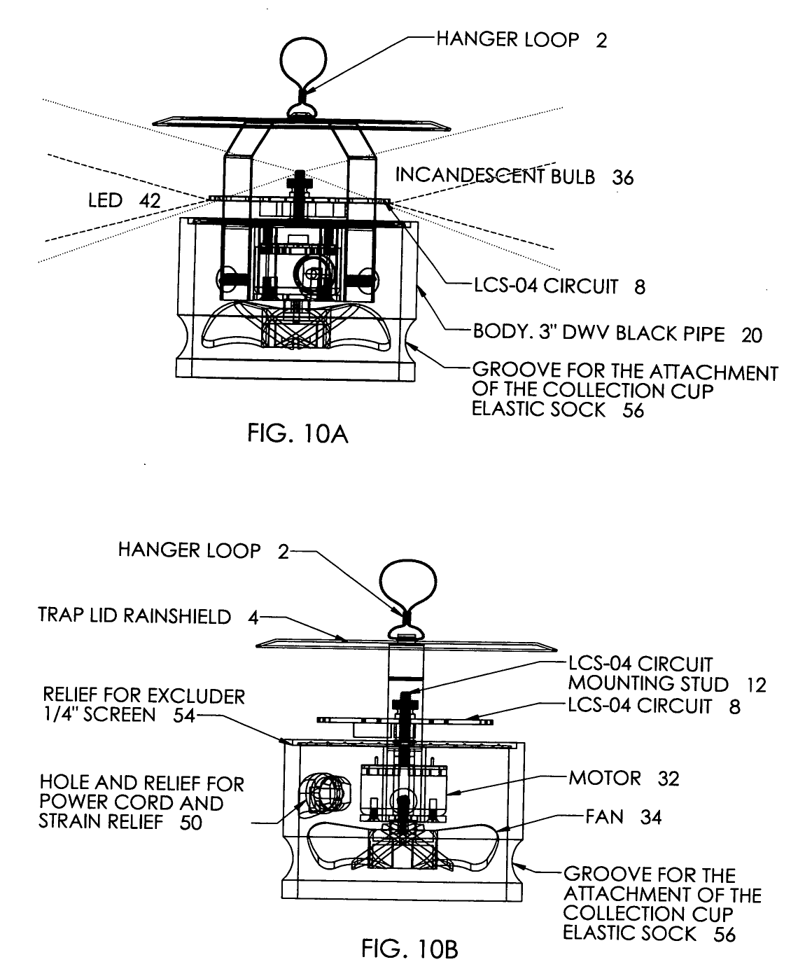

FIG. 10A shows the angles of the light radiation from LED array and the incandescent bulb from within the assembled trap.

FIG. 10B is similar to FIG. 10A also showing the machining in the ABS body 20 of a hole for an electric power cord 50, relief for excluder ¼″ screen 54, relief for the rainshields uprights 52, and a groove for the attachment of the collection cup with elastic sock 56.

The specifics of the preferred ultraviolet LEDs used in the Stealth Trap LED are as follows:
Wavelength: 361 nm
DC forward current: 20 mA
Luminous Intensity: 300-1,200, avg 750 μW
Max Forward Current: 30 mA
Pulse Current: 80 mA for <=10 ms, duty <= 1/10
Forward Voltage: 3.8V typ. @20 mA (8*20=160 mA)
Max Reverse Voltage: 5V
Power Dissipation: 135 mW
Operating Temp: −20 to +85 C
Soldering Temp: 265 C for 10 secs

In 1915 González et al. conducted an extensive field study to compare different wavelengths of light for attracting and trapping Culicoides biting midges, mosquitoes and other dipterans. Comparison of different light sources for trapping culicoides biting midges, mosquitoes and other dipterans. (See Vet Parasitol. 15; 226:44-9.) In their summary of the scientific literature they reviewed some 50 articles on this subject. The key observation from this review was that some species preferred a slightly shorter wavelengths and others longer wavelengths, in the UV-A. The Applicant has concluded that a range of wavelengths between 360 and 365 nm is an optimum. This 360-365 nm range is a very desirable because it happens that this range is where various naturally occurring photo-biological reactions occur including the attraction to sand flies and mosquitoes. The LEDs used in the Stealth Trap are manufactured by The Fox Group, Inc. located at 54 Jennie Dade Lane, Sperryville, Va. 22740 and emit virtually 100% of its radiance at 361±3 nm well within our optimum range for mosquitoes and sand flies.

### Principal of Operation

Flying mosquitoes and/or sand flies are attracted to the trap by use of ultraviolet-emitting (UV) light emitting diodes (LEDs) and/or an incandescent light bulb. A review of the scientific literature indicates that UV radiation is universally attractive to virtually all species and genera of hematophagous adults;² while it is universally attractive to these biting flies, no one has an adequate theory for why UV radiation is attractive. The literature also indicates, again for unknown reasons, that visible light is attractive to a subset of hematophagous adults; probably the hot incandescent bulb also emits in the infrared frequencies which is known to be attractive, again to a subset of hematophagous adults. Another way of saying this is that species and genera of hematophagous attracted to incandescent light are only a subset of the species and genera attracted to UV radiation. To the best of Applicant's knowledge the Stealth Trap utilizing UV-A LEDs can collect all species and genera of hematophagous adults without using CO₂.

The motor and fan of the trap draw ambient air in radially in the circular space between the bottom of the LED array and the top of the ABS cylinder; the airflow is downwards going into the collection cup cloth netting and through the collection cup and screen at the bottom of the cup as indicated in FIG. 2. The machined body shown in FIG. 3 is made of black, ABS foam-core plastic; the material is easy to machine, extremely tough, and dull black in color. After the 3-inch ABS is cut into lengths, it is machine for the following purposes:

(1) A relief for the insect-exclusion ¼—inch screen 10,

(2) Relief for the rain shield support brackets 14,

(3) A hole and relief for the power cord and strain relief 50, and

(4) A groove for attachment of the collection cup elastic sock 56. The top of the sock is a band of elastic which secures the attachment of everything below the trap body 20.

The stainless steel loop 2 is used for hanging the trap. Trap lid 4 also functions as a rain shield.

The LCS-04 printed circuit board shown in FIG. 5 provides: an array of eight LEDs which are arranged radially around the periphery of the board, an incandescent light bulb, photo switch functionality, and three switches. A large insect exclusion screen designed to exclude large insects like beetles which would damage the mosquito/sand fly specimens in the collection cup. The fan and fan motor are mounted on the motor-mounting plate, and the fan support bracket is spot welded to the rain shield mounting bracket. To conserve space the trap assembly, power cord, and collection sock can be stored inside of the collection cup as shown in FIG. 6. The trap and collection cup and sock are preferably either black or camouflage in external finish.

The UV attracter is ultra violet radiation (361 nm); the trap consists of eight UV LEDs. Ninety five percent of all radiation from the UV LEDs is invisible to the human visual range. This combination of camouflage finish and the feature of using UV-A as an attractor, in addition to the other unique features of the invention, is a first for mosquito-sand fly traps. So that the Stealth Trap collections can be directly compared with other miniature light traps using incandescent lights for attractors in the DoD supply chain, the trap has an incandescent bulb that can be used with or in lieu of the UV LEDs.

Sockets are supplied on the LCS-04 PCB so replacement of defective LEDs 42 or the incandescent bi-pin bulb 36 is possible in the field. Also the LED sockets allow for the use with LEDs of different colors. Miniature quick disconnects to allow connection of the LCS-04 with the power cord without tools. The LSC-4 supplies power to the motor.

The entire trap and collection cup have a very small spatial foot print. The trap can be stored inside the collection cup for storage or shipment (FIG. 6A). Because of the narrower collection cup 28, the rain-shield 4 diameter can be substantially smaller than the traditional light traps enabling the trap components with power cord and collection sock to be stored within the collection cup. Dimensions are ca. 5″ (12.0 cm) diameter by 4.25″ (10.5 cm) tall.

The weight of the trap, battery cable, and collection cup and sock is 13 oz (369 g). The individual parts of the trap and collection sock and cup are shown and listed in FIGS. 1 and 2 as described above. The body of the trap 20 is 3-inch ID foam core black ABS plastic as shown in FIGS. 3A and 3B. It is machined to accommodate:

(1) a place to secure the elastic band to the sock 24 going from the trap down to the collection cup 28,

(2) the strain relief of the battery cable 50 and

(3) the large insect exclusion screen 10.

The trap rain shield serves several purposes (FIG. 2): rainshield, attachment point for suspending the trap, and a cover for the collapsed trap stored within the collection cup 28; see also FIG. 6A.

As described above two different sources of radiation for attraction are available:
The single incandescent bulb; a switch permits this bulb to be on or off. The bulb is a bi-pin and can be changed out by simply pulling the light out of its socket. In terms of light output and current required this bi-pin is the same as the bulb used in the traditional light trap in the DoD system.
Two series of four LEDs each emitting in the ultra-violet (wave length: 361 nm). The majority of the radiation is at a frequency too short to be seen by the human eye. This too has an on/off switch. The bi-pin LED sockets permit the use of LEDs of other colors beside UV.

FIG. 10A shows the direction of radiation from the trap:
The axis of the incandescent bulb is normal to the PCB, and radiates spherically upward and radially in the horizontal plane. The rainshield and the edge of the PCB limits (shades) the emission horizontally to 15° upwards and 20° downwards. The filament is directly visible for 360° around the trap.
The eight LEDs on the LCS-04 radiate radially from the center of the circuit; each LED produces an intense cone of radiation of about 30 degrees from the center line or axis of the LED, but the UV light is visible to mosquitos from all 360 degrees surrounding the trap.

FIG. 10B shows a cross sectional view of the trap.

The trap can be run in one of four light modes:
All lights off; the trap simply operates as a suction trap without light attraction.
UV LEDs only, the stealth mode; the circuit was designed to permit changing out LEDs in the field and using different colors of LEDs.
Incandescent only, trap operates like a New Standard Miniature Light Trap, MN 1012 or CDC light trap (NSN: 3740-01-106-0091) in terms of light output and current required and intake in flow. This mode makes collections from the Stealth Trap directly comparable to the mosquito traps already in the DoD's system.
Both incandescent and UV LEDs in operation.

The trap has a single solid state four-layer printed circuit board that functions as a photo switch, power supply and a light array of 8 LEDs and an incandescent light bulb. Notable features of this circuit include:
Power supply that accepts input voltage between 3.8 and 24.0 VDC. In other words, the topology of the power supply is buck/boost. This feature permits the use of lead acid batteries, alkaline batteries, even Li-ion batteries. Moreover, as batteries discharge the fan speed and light output are constant and enable using about. 95% of the energy from the battery.
The circuit is a photo switch, turning everything on a dusk and then in the morning the lights are turned off but the motor continues to keep the specimens from escaping upwards.
Power supply outputs:
   Constant 6.3 VDC for:
      The incandescent light bulb. This constant voltage optimally operates the CM 7349 incandescent bulb at its design voltage.
      The aspiration fan, and
      A carbon dioxide solenoid valve (if so equipped). This provision is for DoD surveillance operations within the United States where compressed carbon dioxide or dry ice is available. This bi-pin solenoid valve is located under the rainshield and plugs in the same manner as the bi-pen incandescent bulb.
   Constant current for the two strings of four LEDs each.
Battery protection from deep discharge. The power supply has two selectable low voltage cutoff points for 6 and 12 VDC rechargeable sealed lead acid batteries at 5.25 and 10.5 volts, respectively, to protect these batteries from going into deep discharge. Power supply has a third mode (again using SW4) where there is no low voltage cutoff; this is to maximize the power from disposable batteries, e.g., four D-cells in series. This permits the use of essentially 95% of the battery capacity without a tapering down of the output to motor or lights.
The incandescent bulb, CM 7349, and the eight LEDs are all attached to the PCB by sockets; this enables the lights to be replaced upon failure OR if visible light LEDs are desired to be substituted for the standard, the UV LEDs.
The LCS-04 can be removed and replaced without tools in the field. LCS-04 circuit schematics are presented in FIGS. 7A-9.

In addition to being stealthy, compact, and not requiring carbon dioxide, the Stealth Trap MN 2014 is extremely efficient meaning smaller batteries and less time for recharging in deployments. Below are run times (motor and LED lights on) for various types of batteries in the DoD logistics supply chain:
a. Four alkaline AA batteries in series: 6 hours.
b. Four Lithium AA batteries in series: 9 hours, a single trap night.
c. Four alkaline D-cell batteries in series: 24 hours, two trap nights.
d. Sealed lead-acid gel-cell battery, 6 volts, 12 amp hour: 36 hours, four trap nights.
e. Sealed lead-acid gel-cell battery, 12 volts, 12 amp hour: 93 hours, ten trap nights.
f. Lithium-ion battery packs, 8.4 volts.

### Variations

Persons skilled in the mosquito trap art will recognize that there are many modification and variations that could be applied to the teachings of the present invention. For example the preferred embodiments described above are specifically directed for use by military applications but these embodiments can be useful in many other situations where there is a need to know the types of flying insects that are present in specific locations. In particular there is currently (as this application is being filed) a great fear of the zika virus. The present invention could be utilized immediately to sample the mosquito population in any region of the United States or anywhere in the world where the mosquitos that carry this virus may potentially be found. Also, many changes and additions to the trap could be made within the scope of the invention. For example various CO₂ sources could be added. Additional light sources could be added and more or fewer than eight LED's could be utilized. In any case the scope of the present invention should be determined by the appended claims and their legal equivalence.

What is claimed is:

1. A stealthy, compact flying insect trap for trapping flying insects in a cloth collection cup comprising:
A) a hollow body machined to provide a port for a battery cable and to accommodate a place to secure the cloth collection cup,
B) an electric fan internally supported by the hollow body and directed to propel air downward through the collection cup cloth netting,
C) an array of UV emitting LED lights,
D) a collection cloth netting suspended below the hollow body,
E) a trap lid rain-shield,
F) a collection cup with a screen at the bottom of the cup,
G) a power cord, and
H) a collection cup ring-like lid positioned above the collection cup when the trap is in use and adapted to form a container, along with the collection cup and the trap lid rain-shield, of the fan, the lights, the cloth netting and the large insect screen when the trap is not in use.

2. The trap as in claim 1 and further comprising at least one incandescent light positioned above, and supported by, the hollow body.

3. The trap as in claim 1 wherein the array of UV emitting LED lights is an array of eight UV emitting LED lights.

4. The trap as in claim 1 and also comprising one or more visual colored LED lights.

5. The trap as in claim 1 and further comprising electronic circuits permitting the trap to be powered by any direct current power source with voltages in the range of 3.8 volts to 24 volts.

6. The trap as in claim 1 wherein the cloth collecting cup is secured to the hollow body by an elastic band.

7. The trap as in claim 1 wherein the collection cloth netting is comprised of sufficiently fine mesh and hydrophobic so that rainfall does not enter the cloth collection cup.

8. The trap as in claim 2 wherein the array of eight LED's and the incandescent light are mounted on a printed circuit board that also contains a photo-switch and other switches permitting at least four modes of lighting including: A) UV LED only, B) incandescent only, C) UV and incandescent and D) no light.
